(19) United States
(12) Patent Application Publication
(10) Pub. No.: US 2021/0151733 A1
(43) Pub. Date: May 20, 2021

(54) ELECTRODE FOR SECONDARY BATTERY AND METHOD OF MANUFACTURING SAME

(71) Applicants: HYUNDAI MOTOR COMPANY, SEOUL (KR); KIA MOTORS CORPORATION, SEOUL (KR)

(72) Inventors: Yeol Mae YEO, Hwaseong-si (KR); Sung Hoon LIM, Yongin-si (KR); Nam Hyeong KIM, Gimcheon-si (KR); Ji Eun LEE, Hwaseong-si (KR); Dong Jun KIM, Seongnam-si (KR); Sang Mok PARK, Gwangju-si (KR); Seung Min OH, Incheon (KR)

(73) Assignees: HYUNDAI MOTOR COMPANY, SEOUL (KR); KIA MOTORS CORPORATION, SEOUL (KR)

(21) Appl. No.: 16/993,659

(22) Filed: Aug. 14, 2020

(30) Foreign Application Priority Data
Nov. 18, 2019 (KR) 10-2019-0147861

(51) Int. Cl. H01M 4/04; H01M 10/0525; H01M 4/75; H01M 4/62; H01M 4/38; H01M 4/583; H01M 4/66

(52) U.S. Cl. CPC H01M 4/0404; H01M 10/0525; H01M 4/75; H01M 4/661; H01M 4/386; H01M 4/583; H01M 4/622

(57) ABSTRACT

An electrode for a secondary battery and method of manufacturing the electrode for the secondary battery are provided. The electrode for the secondary battery may include: a cathode current collector; and a layer coated on the cathode current collector and in which metal nanowires are embedded in a binder material.

### CROSS-REFERENCE TO RELATED APPLICATION

The present application claims priority to and the benefit of Korean Patent Application No. 10-2019-0147861, filed Nov. 18, 2019, which is incorporated herein by reference in its entirety.

### TECHNICAL FIELD

The present disclosure relates to an electrode for a secondary battery and a method of manufacturing the same.

### BACKGROUND

The statements in this section merely provide background information related to the present disclosure and may not constitute prior art.

Due to tightening environmental regulations, high oil prices, depletion of fossil energy, and the like, there is an increasing interest in electric vehicles and hybrid electric vehicles that can replace vehicles using fossil fuels such as gasoline vehicles, diesel vehicles, and the like.

Currently, nickel-metal hydride secondary batteries are mainly used as a power source of electric vehicles. However, there is active research regarding the use of lithium secondary batteries which have higher output density (equal to or greater than three times the nickel-metal hydride secondary batteries), longer cycle life, and lower self-discharge rate than the nickel-metal hydride secondary batteries as a main power source of electric vehicles.

Meanwhile, in the related art, when manufacturing a battery cell to which a cathode containing Si is applied in a lithium secondary battery, there is a problem in that when the amount of binder is insufficient, as shown in FIG. 1, delamination between a current collector and an electrode may occur after coating/drying. In the battery cell in the related art, there is another problem in that delamination between the current collector and the electrode may occur due to volume expansion of Si during charging/discharging of a Si electrode, leading to a loss of an electrical network between active materials.

### SUMMARY

Accordingly, the present disclosure provides an electrode for a secondary battery and a method of manufacturing the same in which a binder material in which metal nanowires are embedded is coated on a cathode current collector, thereby reducing delamination between the current collector and the electrode during charging/discharging.

In one aspect of the present disclosure, there is provided an electrode for a secondary battery, the electrode including: a cathode current collector; and a layer coated on the cathode current collector and in which metal nanowires are embedded in a binder material.

The metal nanowires may be one of copper nanowires, silver nanowires, and nickel nanowires.

The binder material may be a polyimide and, the polyimide may be prepared using a diisocyanate as a monomer.

The layer may be coated on the cathode current collector by using one of bar coating, gravure coating, and die coating.

The layer may be coated such that an electrical resistance of the cathode current collector with the layer coated on a surface thereof may not exceed twice an electrical resistance of a cathode current collector without the layer coated on a surface thereof.

A volume ratio of the metal nanowires to the polyimide may be 1:1 to 2:1.

The layer coated on the cathode current collector may have a thickness that is equal to or greater than a length of one metal nanowire and may be equal to or less than a thickness of the cathode current collector.

In another aspect of the present disclosure, there is provided a method of manufacturing an electrode for a secondary battery, the method including: preparing a cathode current collector; preparing a polyamic acid (PAA); preparing a mixture by mixing the prepared polyamic acid and metal nanowires; coating the mixture on the cathode current collector; and performing primary drying to form a layer on the cathode current collector.

In the preparing the polyamic acid, the polyamic acid may be prepared by synthesizing a dianhydride and a diisocyanate.

The metal nanowires may be one of copper nanowires, silver nanowires, and nickel nanowires.

The coating the mixture on the cathode current collector may be performed by using one of bar coating, gravure coating, and die coating.

The performing the primary drying to form the layer on the cathode current collector may be performed by drying the cathode current collector within 1 minute at a temperature of 70 to 100 degrees Celsius.

The method may further include performing secondary drying, wherein the performing the secondary drying may be performed by drying the cathode current collector within 6 to 12 hours at a temperature of equal to or greater than 120 degrees Celsius.

In some forms of the present disclosure, by coating the binder material in which the metal nanowires are embedded on the cathode current collector, it may be possible to reduce delamination between the current collector and the electrode during charging/discharging.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing a state in which delamination between a current collector and an electrode is occurred after coating/drying due to an insufficient amount of binder in a battery cell in the related art;

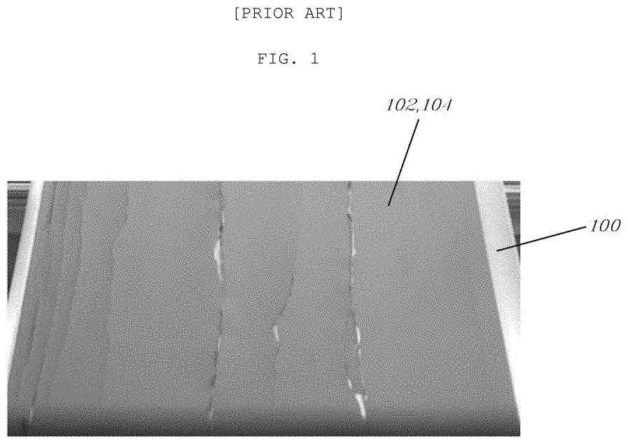

FIG. 2 is a view showing a state in which delamination between the current collector and the electrode is occurred due to volume expansion of Si during charging/discharging of a Si electrode in the battery cell in the related art;

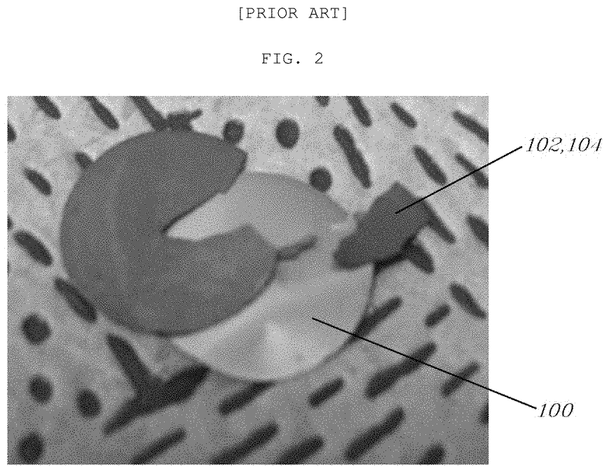

FIG. 3 is a view schematically showing a configuration of the electrode including silicon and graphite in the battery cell in the related art;

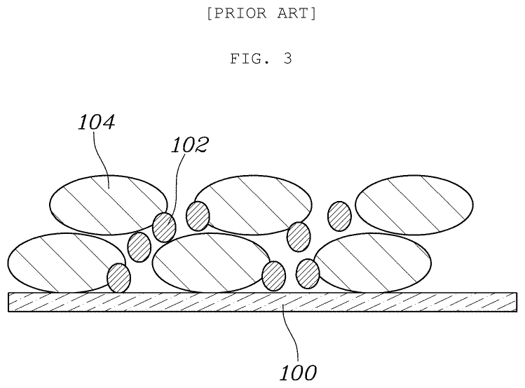

FIG. 4 is a view schematically showing a state of the electrode after charging/discharging of the electrode including silicon and graphite in the battery cell in the related art;

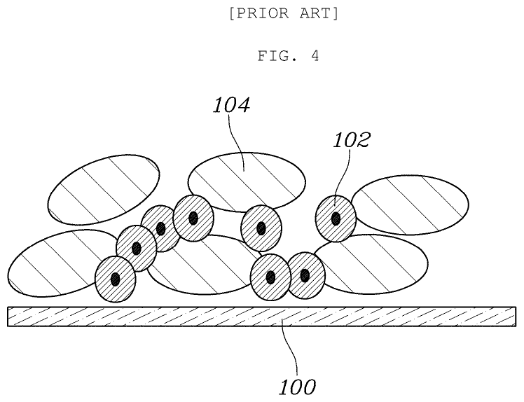

FIG. 5 is a view schematically showing a configuration of an electrode for a secondary battery in one form of the present disclosure;

FIG. 6 is a view schematically showing a state of the electrode after charging/discharging of the electrode for the secondary battery in one form of the present disclosure;

FIG. 7 is a view showing preparation of a polyimide in the electrode for the secondary battery in one form of the present disclosure; and

FIG. 8 is a flowchart showing a method of manufacturing an electrode for a secondary battery in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinbelow, some forms of the present disclosure will be described in detail with reference to the accompanying drawings. Unless otherwise defined, all terms including technical and scientific terms used herein have the same meaning as commonly understood by one of ordinary skill in the art to which some forms of this disclosure belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

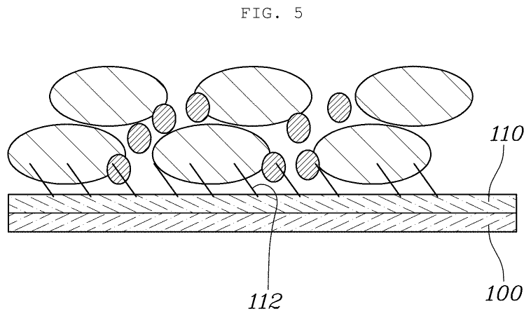

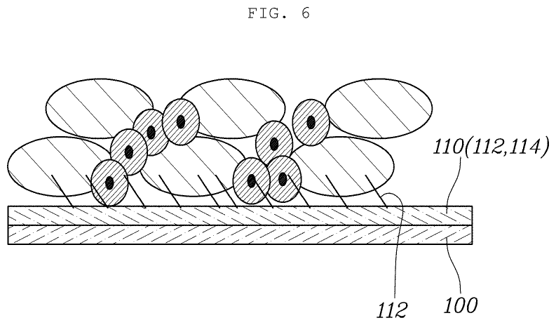

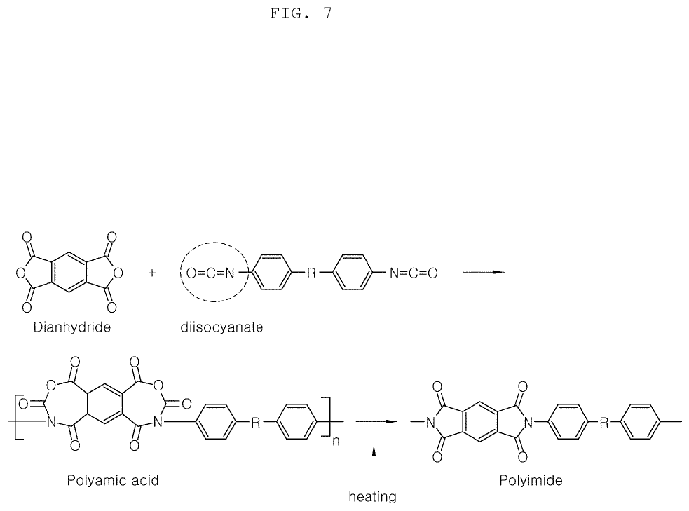

FIG. 5 is a view schematically showing a configuration of an electrode for a secondary battery in some forms of the present disclosure, FIG. 6 is a view schematically showing a state of the electrode after charging/discharging of the electrode for the secondary battery in some forms of the present disclosure, FIG. 7 is a view showing preparation of a polyimide in the electrode for the secondary battery in some forms of the present disclosure.

Referring to FIG. 5, an electrode for a secondary battery in some forms of the present disclosure includes a cathode current collector 100, and a layer 110 coated on the cathode current collector 100 and in which metal nanowires 112 are embedded in a binder material 114. Herein, the cathode current collector 110 may be any conductor. In some forms of the present disclosure, the cathode current collector 110 may be copper, aluminum, stainless steel, nickel plated steel, or the like, but is not limited thereto. In addition, in some forms of the present disclosure, the metal nanowires 112 may be one of copper nanowires, silver nanowires, and nickel nanowires. However, this is only one form of the present disclosure, and various other metal nanowires may be used in the present disclosure as long as being stable in the available potential range of a lithium secondary battery and not reacting with lithium.

A cathode active material layer including a cathode active material may be formed on the cathode current collector 100. Herein, the cathode active material may include a silicon-based active material, a tin-based active material, or a combination thereof. A carbon-based active material is a material that includes carbon (atoms) and electrochemically inserts and extracts lithium ions. In some forms of the present disclosure, the carbon-based active material may be a graphite active material, artificial graphite, natural graphite, a mixture of artificial graphite and natural graphite, natural graphite coated with artificial graphite, or the like, but is not limited thereto.

Meanwhile, the binder material 114 included in the layer 110 may be a polyimide. In addition, the polyimide may be prepared using a diisocyanate as a monomer. Preparation of the polyimide will be described in more detail later with reference to FIG. 7.

In addition, in some forms of the present disclosure, the layer 110 may be coated on the cathode current collector 100 by using one of bar coating, gravure coating, and die coating. Herein, it is preferable that the layer 110 is coated such that the electrical resistance of the cathode current collector 100 with the layer 110 coated on the surface thereof does not exceed twice the electrical resistance of a cathode current collector 100 without the layer 110 coated on the surface thereof. In some forms of the present disclosure, when the cathode current collector 100 is a copper current collector, it is preferable that if the electrical resistance of a copper current collector without the layer 110 coated on the surface thereof is 1.678 microhm*cm at 20 degrees Celsius, the electrical resistance of a copper current collector 100 with the layer 110 coated on the surface thereof does not exceed 3.356 microhm*cm at 20 degrees Celsius.

Herein, the reason why the layer 110 has to be coated such that the electrical resistance of the cathode current collector 100 with the layer 110 coated on the surface thereof does not exceed twice the electrical resistance of a cathode current collector 100 without the layer 110 coated on the surface thereof as follows.

Due to the fact that the layer including the polyimide is formed on the cathode current collector, there is a problem in that the electrical resistance of the cathode current collector may increase due to the polyimide and the like. Due to this reason, in order to allow the cathode current collector to serve as an original cathode current collector while fulfilling the objective of preventing delamination between the current collector and the electrode, it is preferable that the layer is coated such that the electrical resistance of the cathode current collector with the layer coated on the surface thereof does not exceed twice the electrical resistance of the cathode current collector without the layer coated on the surface thereof. In other words, coating more layers on the cathode current collector can more effectively solve the problem of delamination between the current collector and the electrode. However, in this case, the current collector may not serve as the original current collector due to increased electrical resistance.

Furthermore, it is preferable that the volume ratio of the metal nanowires to the polyimide included in the layer 110 is 1:1 to 2:1. The polyimide included in the layer 110 may increase the electrical resistance of the cathode current collector 100, while the metal nanowires 112 may decrease the resistance of the cathode current collector 100. Accordingly, as described above, to solve the problem of delamination between the current collector and the electrode during charging/discharging of a battery, while enabling the battery to operate optimally in consideration of the electrical resistance of the cathode current collector, it is preferable that the volume ratio of the metal nanowires and the polyimide included in the layer coated on the cathode current collector is 1:1 to 2:1.

Furthermore, the layer 110 coated on the cathode current collector 100 may have a thickness that is equal to or greater than the length of one metal nanowire and is equal to or less than the thickness of the cathode current collector used. In some forms of the present disclosure, when the length of one metal nanowire used is 1 μm and the thickness of the cathode current collector is 12 μm, the thickness of the layer 110 coated on the cathode current collector 100 may be 1 to 12 μm.

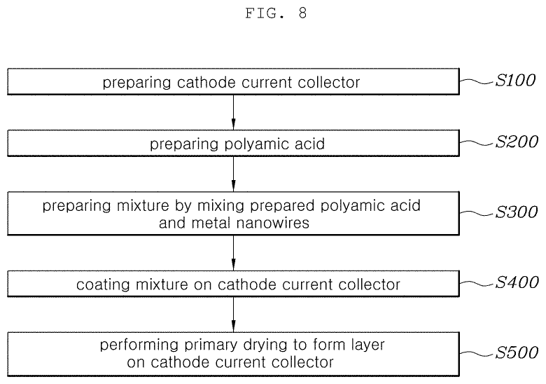

FIG. 8 is a flowchart showing a method of manufacturing an electrode for a secondary battery in some forms of the present disclosure. Referring to FIG. 8, the method of manufacturing the electrode for the secondary battery in some forms of the present disclosure may include preparing a cathode current collector, preparing a polyamic acid (PAA), preparing a mixture by mixing the prepared polyamic acid and metal nanowires, coating the mixture on the cathode current collector, and performing primary drying to form a layer on the cathode current collector.

The cathode current collector prepared in the preparing the cathode current collector may be any conductor. In some forms of the present disclosure, the cathode current collector may be copper, aluminum, stainless steel, or nickel plated steel, but is not limited thereto.

In the preparing the polyamic acid, the polyamic acid may be prepared by synthesizing dianhydride and diisocyanate monomers as shown in FIG. 7.

When the polyamic acid is prepared according to the above-described method, the prepared polyamic acid and the metal nanowires may be mixed to prepare a mixture. Herein, the prepared mixture may be a mixture of a polyamic acid and metal nanowires in N-methyl-2-pyrrolidone (NMP) solvent. Herein, in some forms of the present disclosure, the metal nanowires may be one of copper nanowires, silver nanowires, and nickel nanowires. However, this is only one form of the present disclosure, and various other metal nanowires may be used in the present disclosure as long as being stable in the available potential range of a lithium secondary battery and not reacting with lithium.

Meanwhile, in the coating the mixture on the cathode current collector, the mixture may be coated on the cathode current collector by using one of bar coating, gravure coating, and die coating.

In addition, in the performing the primary drying to form the layer on the cathode current collector, the cathode current collector may be dried within 1 minute at a temperature of 70 to 100 degrees Celsius. As such, when the cathode current collector with the mixture coated on the surface thereof is dried within 1 minute at a temperature of 70 to 100 degrees Celsius, the NMP solvent is volatilized after the primary drying whereby a layer in which the metal nanowires are embedded in the polyamic acid is formed on the cathode current collector.

Meanwhile, the method of manufacturing the electrode for the secondary battery in some forms of the present disclosure may further include performing secondary drying. In detail, the performing the secondary drying is a solvent drying and vacuum drying process after electrode coating in a manufacturing process of a battery cell, and the drying may be performed within 6 to 12 hours at a temperature of equal to or greater than 120 degrees Celsius. After the performing the second drying, a layer may be formed in which the metal nanowires are embedded in a polyimide.

Referring to FIGS. 5 and 6, the electrode for the secondary battery in some forms of the present disclosure is characterized by coating a layer in which metal nanowires are embedded in a polyimide on the surface of a cathode current collector. This ensures that even when charging/discharging of a battery occurs, as shown in FIG. 6, the surface roughness can be increased by the metal nanowires and adhesive force is increased by the polyimide, thereby minimizing delamination between the current collector and an active material.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electrode for a secondary battery, the electrode comprising:
a cathode current collector; and
a layer coated on the cathode current collector and in which metal nanowires are embedded in a binder material.

2. The electrode of claim 1, wherein the metal nanowires are one of copper nanowires, silver nanowires, or nickel nanowires.

3. The electrode of claim 1, wherein the binder material is a polyimide and, the polyimide is prepared using a diisocyanate as a monomer.

4. The electrode of claim 1, wherein the layer is coated on the cathode current collector by using one of bar coating, gravure coating, or die coating.

5. The electrode of claim 1, wherein the layer is coated such that an electrical resistance of the cathode current collector with the layer coated on a surface thereof does not exceed twice an electrical resistance of a cathode current collector without the layer coated on a surface thereof.

6. The electrode of claim 3, wherein a volume ratio of the metal nanowires to the polyimide is 1:1 to 2:1.

7. The electrode of claim 1, wherein the layer coated on the cathode current collector has a thickness that is equal to or greater than a length of one metal nanowire and is equal to or less than a thickness of the cathode current collector.

8. A method of manufacturing an electrode for a secondary battery, the method comprising:
preparing a cathode current collector;
preparing a polyamic acid (PAA);
preparing a mixture by mixing the prepared polyamic acid and metal nanowires;
coating the mixture on the cathode current collector; and
performing primary drying to form a layer on the cathode current collector.

9. The method of claim 1, wherein preparing the PAA further comprises:
preparing the PAA by synthesizing a dianhydride and a diisocyanate.

10. The method of claim 8, wherein the metal nanowires are one of copper nanowires, silver nanowires, or nickel nanowires.

11. The method of claim 8, wherein coating the mixture on the cathode current collector further comprises:
coating the mixture on the cathode current collector by using one of bar coating, gravure coating, or die coating.

12. The method of claim 8, wherein performing the primary drying to form the layer on the cathode current collector further comprises:
performing the primary dying by drying the cathode current collector within 1 minute at a temperature of 70 to 100 degrees Celsius.

13. The method of claim 8, wherein the method further comprises:
performing secondary drying by drying the cathode current collector within 6 to 12 hours at a temperature of equal to or greater than 120 degrees Celsius.
